(19) United States
(12) Patent Application Publication
(10) Pub. No.: US 2026/0037310 A1
(43) Pub. Date: Feb. 5, 2026

(54) DYNAMIC RESOURCE ALLOCATION FOR CONCURRENT GPU WORKLOADS

(71) Applicant: NVIDIA Corporation, Santa Clara, CA (US)

(72) Inventors: Harini Muthukrishnan, Austin, TX (US); Oreste Villa, West Richland, WA (US); David Nellans, Round Rock, TX (US)

(21) Appl. No.: 18/791,148

(22) Filed: Jul. 31, 2024

(51) Int. Cl. G06F 9/50

(52) U.S. Cl. CPC G06F 9/5027

(57) ABSTRACT

While the capabilities of GPUs are being consistently enhanced with each new generation thereby enabling them to process data at a faster rate, many applications configured to execute on the GPU do not exploit the full potential of a GPU. To better utilize GPU resources and to more efficiently run applications, applications can be co-scheduled on the GPU such that the GPU concurrently executes processes of the co-scheduled applications. However, current GPU scheduling solutions are limited in that they either do not consider the QoS requirements of an application or do not allow for dynamic allocations during application execution. The present disclosure provides for dynamic allocation of GPU resources for concurrent processes which can optimize GPU resource utilization while minimizing power consumption and adhering to QoS requirements of each application.

### TECHNICAL FIELD

The present disclosure relates to concurrent process execution on a graphics processing unit (GPU).

### BACKGROUND

While the capabilities of GPUs are being consistently enhanced with each new generation thereby enabling them to process data at a faster rate, many applications configured to execute on the GPU do not exploit the full potential of a GPU. To better utilize GPU resources and to more efficiently run applications, applications can be co-scheduled on the GPU such that the GPU concurrently executes processes of the co-scheduled applications.

However, current GPU scheduling solutions are limited. For example, one approach aims to minimize idle time of GPU resources, but scheduling is done without consideration for quality of service (QoS) requirements of an application. For example, this approach cannot determine performance of an application nor can it prioritize one application over another. As a result, this approach is not suitable for any application processes that have certain QoS requirements, such as real-time processing requirements.

Another approach improves the first approach by allowing a maximum percentage of resources to be allocated to an application to be specified. However, the percentage is static and cannot be dynamically changed during application execution, which makes it impossible to prioritize applications that do not begin execution at the same time.

Yet another approach partitions the GPU into a predetermined number of instances at GPU boot time. Accordingly, this static approach does not allow for modifications based on an application's runtime requirements. A final approach allows a percentage of resources to be allocated to a certain application process to be predefined, but this approach requires that the percentage and corresponding process be declared in the application code itself. Requiring every application to declare the GPU resources required for each of its processes results in a solution that is not adaptable to applications that have not been developed to include such information.

There is thus a need for addressing these and/or other issues associated with the prior art. For example, there is a need to provide dynamic allocation of GPU resources for concurrent processes.

### SUMMARY

A method, non-transitory computer-readable media, and system are disclosed for dynamic allocation of GPU resources for concurrent processes. A state of graphics processing unit (GPU) resource allocations to one or more processes is determined. At runtime of at least one process of the one or more processes, the GPU resource allocations are modified based on the state and a preconfigured resource allocation policy.

### BRIEF DESCRIPTION OF THE DRAWINGS

FIG. 1 illustrates a method for modifying GPU resource allocations among concurrent processes at runtime, in accordance with an embodiment.

FIG. 2 illustrates a system for modifying GPU resource allocations among concurrent processes at runtime, in accordance with an embodiment.

FIG. 3 illustrates a method for dynamically modifying GPU resource allocations for concurrently running processes, in accordance with an embodiment.

FIG. 4 illustrates a method for dynamically modifying GPU resource allocations to satisfy process QoS requirements, in accordance with an embodiment.

FIG. 5 illustrates a block diagram of a kernel-level GPU resource allocation, in accordance with an embodiment.

FIG. 6 illustrates a network architecture, in accordance with an embodiment.

FIG. 7 illustrates an exemplary system, in accordance with an embodiment.

### DETAILED DESCRIPTION

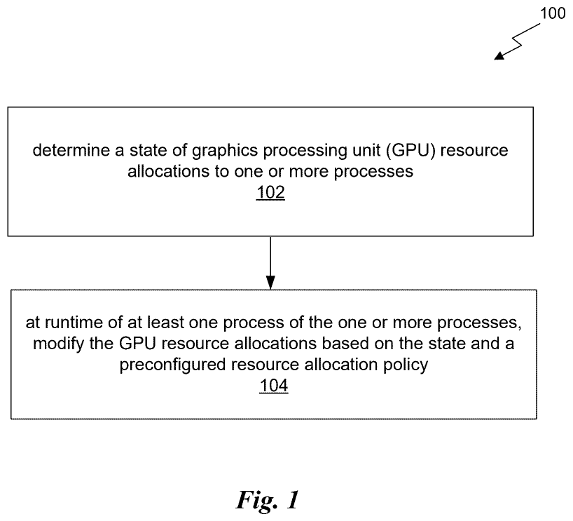

FIG. 1 illustrates a method 100 for modifying GPU resource allocations among concurrent processes at runtime, in accordance with an embodiment. In an embodiment, the method 100 may be performed by a combination of software and hardware. In an embodiment, the method 100 may be performed only in software. In an embodiment, the method 100 may be performed only in hardware. In embodiments, the hardware may be a graphics processing unit (GPU), a central processing unit (CPU), a specialized hardware, and/or any other computer hardware configured to perform the method 100.

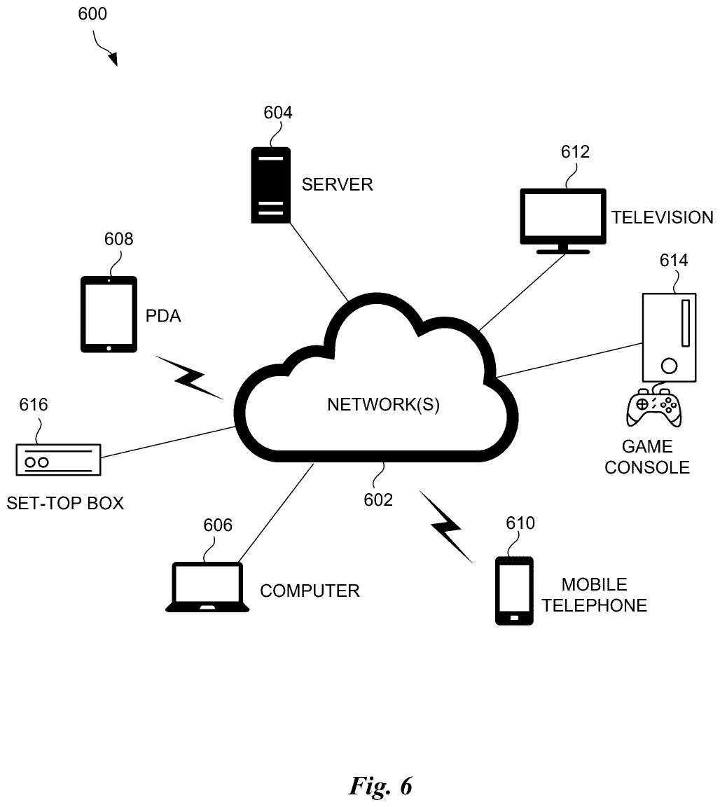

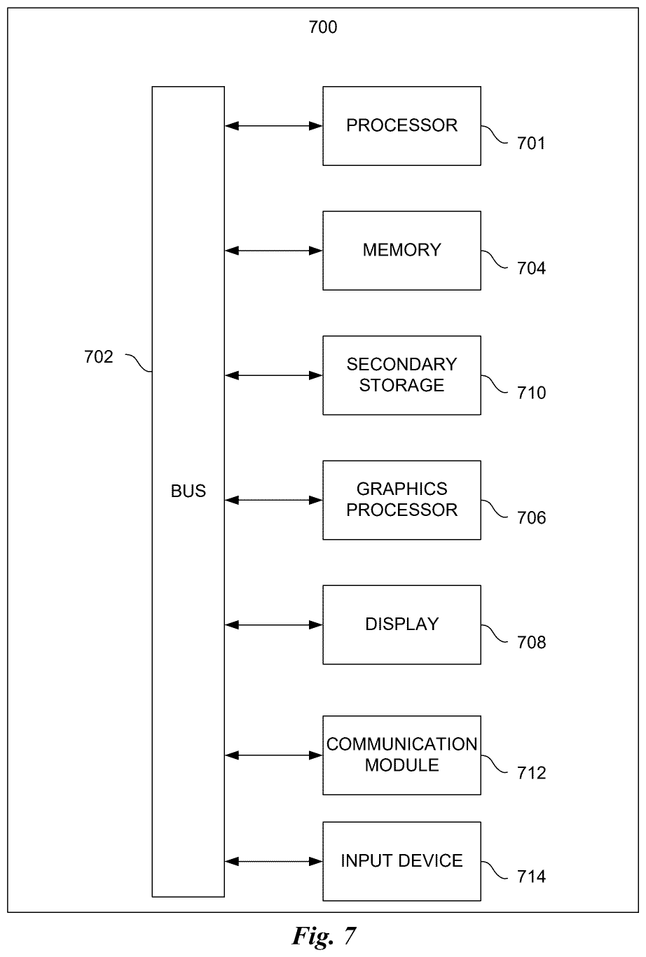

In an embodiment, the hardware may be included in a device, which may be comprised of a processing unit, a program, custom circuitry, or a combination thereof, in an embodiment. In another embodiment, the hardware may be included in a system, which may be comprised of a non-transitory memory storage comprising software (instructions) and one or more processors in communication with the memory which execute the software. As an example, the method 100 may be performed in the context of the devices in the network architecture 600 of FIG. 6 and/or in the context of the system 700 of FIG. 7.

In operation 102, a state of GPU resource allocations to one or more processes is determined. With respect to the present description, a process refers to an instance of computer code that is being executed by the GPU. In an embodiment, the process may be an application-level process, context-level process, stream-level process, or kernel-level process.

In an embodiment, multiple processes may be concurrently executing on the GPU. The multiple processes may be concurrently executed by interleaving execution of the processes on the GPU. The multiple processes may be concurrently executed by time slicing execution of the processes on the GPU.

As mentioned, GPU resource allocations are made to one or more processes. The GPU resource allocations refer to allocations (e.g. assignments) of GPU resources across the one or more processes. The GPU resources may be streaming multiprocessors of the GPU or any other hardware components of the GPU capable of being used to execute the one or more processes. An allocation of a GPU resource to a process may cause the GPU to execute the process using the GPU resource.

The state of the GPU resource allocations refers to a status of at least a portion of the GPU resources as it relates to allocations across the one or more processes. In an embodiment, the state may indicate usage of GPU resources. In an embodiment, the state may indicate assignments of GPU resources to the one or more processes. In an embodiment, the state may indicate unassigned GPU resources.

In an embodiment, the state may be determined from a map of GPU resources that is periodically updated with a current state of GPU resource allocations. In an embodiment, the state may be updated at one or more assignments of GPU resources (i.e. to one or more processes) and at one or more releases of GPU resources (i.e. previously assigned to one or more processes). In an embodiment, the one or more assignments of GPU resources and the one or more releases of GPU resources may be identified from callbacks triggered by hardware.

In operation 104, at runtime of at least one process of the one or more processes, the GPU resource allocations are modified based on the state and a preconfigured resource allocation policy. Modifying the GPU resource allocations refers to reallocating at least a portion of the GPU resources across at least a portion of the one or more processes. Thus, modifying the GPU resource allocations may include adjusting an allocation of GPU resources among the one or more processes and/or additional processes. In an embodiment, modifying the GPU resource allocations may include increasing GPU resources allocated to at least one of the processes, decreasing GPU resources allocated to at least one of the processes, removing an allocation of GPU resources to at least one of the processes, etc.

The preconfigured resource allocation policy refers to a policy by which GPU resources are to be allocated to processes for execution. The preconfigured resource allocation policy may be used to modify the GPU resource allocations with respect to the one or more processes. The preconfigured resource allocation policy may be used to modify the GPU resource allocations with respect to one or more additional processes to be executed.

In an embodiment, the preconfigured resource allocation policy may be a function that determines a target GPU resource allocation based on the state. In an embodiment, the preconfigured resource allocation policy may determine the target GPU resource allocation according to one or more defined parameters. The parameters may be defined by a user via a graphical user interface (GUI). For example, the parameters may be input to the preconfigured resource allocation policy to generate the target GPU resource allocation.

The one or more defined parameters may include prioritization among the one or more processes, in an embodiment. In an embodiment, the one or more defined parameters may include an objective for GPU resource allocation, where such objective may be to optimize GPU resource utilization, minimize power consumption, adhere to QoS requirements of the one or more processes, etc., or any combination thereof. The one or more defined parameters may include QOS requirements of the one or more processes. QoS requirements of a process may be defined as resource requirements of the process, in an embodiment.

In an embodiment, the preconfigured resource allocation policy may determine the target GPU resource allocation based on historical data indicating one or more previous GPU resource allocations given to at least one process of the one or more processes and a resulting performance of the at least one process. For example, knowledge about the amount of GPU resources allocated to a process during a previous execution of the process as well as knowledge about whether the allocated resources met the QoS requirements of the process may be considered by the preconfigured resource allocation policy when determining the target GPU resource allocation. In an embodiment, the preconfigured resource allocation policy may be learned (e.g. via a machine learning algorithm) based on the historical data. In an embodiment, the preconfigured resource allocation policy may be defined based on a prediction of future process executions and performance (e.g. by a machine learning model).

In any case, the GPU resource allocations may be modified in accordance with the target GPU resource allocation determined by the preconfigured resource allocation policy. In an embodiment, the method 100 may also include tracking time of utilization of GPU resources. In an embodiment, the method 100 may also include using hardware performance counters to track at least one of memory utilization, cache utilization, and/or power utilization. In an embodiment, the GPU resource allocations may be modified based on the hardware performance counters.

In an embodiment, the GPU resource allocation may be modified by instructing the GPU to adjust the allocation of GPU resources among the one or more processes. In an embodiment, the GPU resource allocations may be modified by allocating a predefined amount of GPU resources to a first queue storing a first plurality of kernels where the first queue stores at least one kernel to be prioritized over other kernels, and then allocating remaining GPU resources among remaining queues each storing a respective plurality of kernels.

To this end, the method 100 may be performed to modify GPU resource allocations among concurrent processes during a runtime of at least one of the processes. The method 100 may be triggered upon detection of a particular event, such as completion of execution of one of the processes or initiation of execution of a process or a change to QoS requirements of a process being executed. The method 100 may be triggered upon detection of a particular performance state, such as when QoS requirements of the processes are not being met or when a defined objective is not being met. In any case, the method 100 provides dynamic GPU resource allocations among concurrently executing processes.

In one exemplary implementation of the method 100, a current state of allocations of resources of a GPU to a set of processes concurrently executing on the GPU is identified. The current state may be identified from a map of GPU resources that is periodically updated with a current state of GPU resource allocations. At least one change to the set of processes may be detected, including a removal of one or more existing processes from the set of processes (e.g. upon execution completion), an addition of one or more new processes to the set of process (e.g. upon execution initiation), and/or a modification to resource requirements of an existing process in the set of processes. Responsive to detecting the at least one change, a reallocation of the resources among processes in the changed set of processes is determined, where the reallocation targets at least one objective that includes, at least in part, satisfying QoS requirements defined for one or more processes in the new set of processes. The at least one objective may be determined using a preconfigured resource allocation policy. At runtime of at least one process in the changed set of processes, the GPU may be caused to concurrently execute the new set of processes in accordance with the reallocation of the resources.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

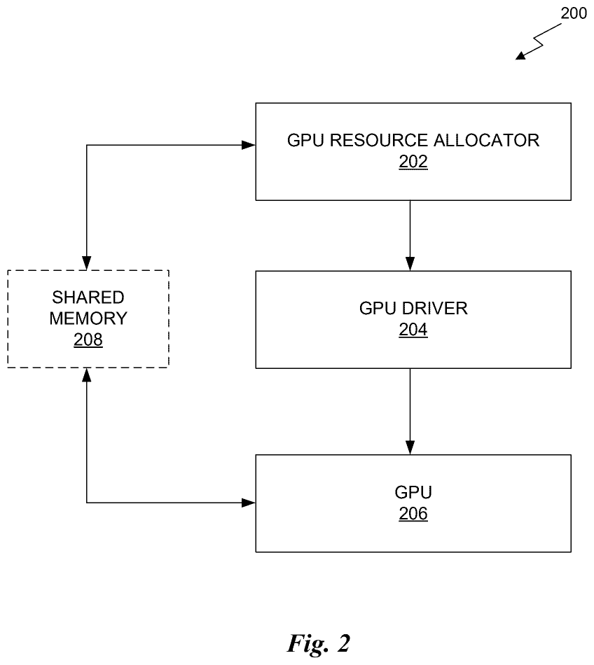

FIG. 2 illustrates a system 200 for modifying GPU resource allocations among concurrent processes at runtime, in accordance with an embodiment. The system 200 may be implemented in the context of any of the prior disclosed embodiments. For example, the system 200 may be implemented to carry out the method 100 of FIG. 1. Of course, the system 200 may be implemented in any desired context. Further, the aforementioned definitions and descriptions may equally apply to the present embodiments.

As shown, the system 200 includes a GPU resource allocator 202. In an embodiment, the GPU resource allocator 202 may be implemented in software of the system 200. In an embodiment, the GPU resource allocator 202 may be implemented in hardware of the system 200. For example, the GPU resource allocator 202 may be implemented in the GPU 206 of the system 200. In an embodiment, the GPU resource allocator 202 may be implemented in a combination of hardware and software of the system 200.

The GPU resource allocator 202 is configured to cause resources of the GPU 206 to be dynamically allocated to processes for execution. The processes may execute concurrently on the GPU 206, at least in part. The processes may be application-level processes, context-level processes, stream-level processes, or kernel-level processes, in various embodiments.

The GPU resource allocator 202 may be triggered to determine GPU resource allocations upon one or more predefined events occurring, such as a new process instructed to be executed and/or an existing process completing execution. The GPU resource allocator 202 may be triggered to determine GPU resource allocations upon a determination that an existing GPU resource allocation is not meeting a preconfigured objective, such as to optimize GPU resource utilization, minimize power consumption, adhere to QoS requirements of the one or more processes, etc.

The GPU resource allocator 202 determines a state of GPU resource allocations to one or more processes. In an embodiment, the state may indicate one or more processes running on the GPU 206. In an embodiment, the state may indicate assignments of GPU resources to the one or more processes. In an embodiment, the state may indicate unassigned GPU resources.

In an embodiment, the state may be determined from a map of GPU resources that is periodically updated with a current state of GPU resource allocations. In an embodiment, the state may be updated at one or more assignments of GPU resources (i.e. to one or more processes) and at one or more releases of GPU resources (i.e. previously assigned to one or more processes). In an embodiment, the one or more assignments of GPU resources and the one or more releases of GPU resources may be identified from callbacks triggered by hardware of the system 200.

Further, at runtime of at least one process of the one or more processes, the GPU resource allocator 202 modifies the GPU resource allocations based on the state and a preconfigured resource allocation policy. In an embodiment, the GPU resource allocator 202 may also modify the GPU resource allocations based various performance metrics associated with the GPU 206, such as memory utilization, cache utilization, power utilization, etc. These performance metrics may be monitored using hardware performance counters, in an embodiment.

The preconfigured resource allocation policy guides the allocation of the GPU resources. In an embodiment, the preconfigured resource allocation policy may define an objective by which the GPU resource allocation is to be determined. For example, the GPU resource allocator 202 may consider QoS requirements of concurrently executing processes, needs of the processes, prioritization among the processes, overall power consumption by the processes, and/or any other factor related to execution of the processes on the GPU 206.

The modified GPU resource allocations are communicated by the GPU resource allocator 202 to a GPU driver 204. The GPU driver 204 causes the GPU 206 to execute each of the processes using the resources allocated to the process. For example, a QMD data structure of the GPU driver 204 may be updated per the modified GPU resource allocations, and the QMD data structure may then be launched by the GPU 206.

When the GPU resource allocator 202 is implemented in software, the GPU 206 may return performance information (e.g. performance counters) and execution information (e.g. the map) back to a shared memory 208 for use by the GPU resource allocator 202 to make further resource allocation modifications.

When the GPU resource allocator 202 is implemented in the GPU 206, the GPU 206 may run the GPU resource allocator 202 as a scheduler program (e.g. which may be programmable) that includes logic for monitoring the performance and execution information to make further resource allocation modifications. In this embodiment, the hardware-based GPU resource allocator 202 may accept GPU process (e.g. kernel) execution requests from the GPU driver 204 and the operating system may then determine the GPU resource allocations per the preconfigured resource allocation policy. In this embodiment, priority information for the processes may be obtained from an operating system scheduler, such that violation of system-wide QoS requirements may be prevented while optimizing for local GPU 206 efficiency and local (process) QoS requirements.

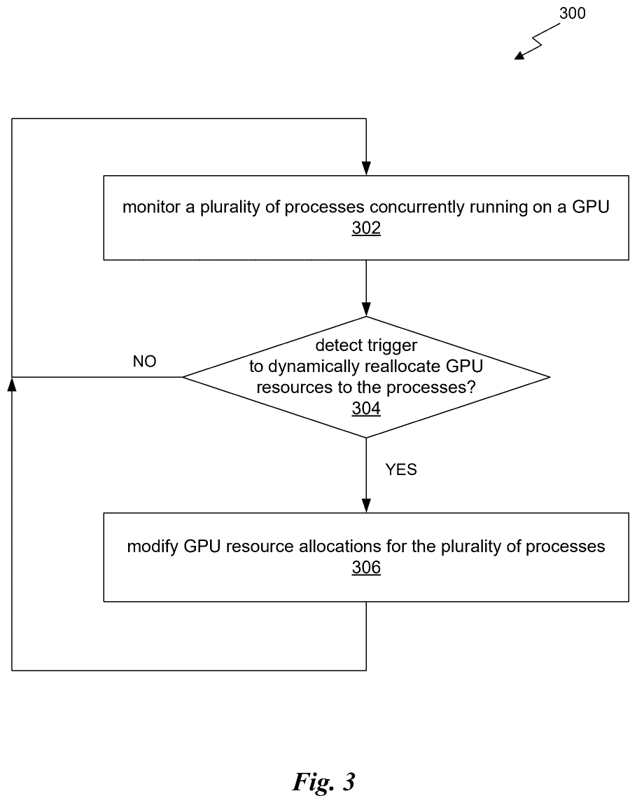

FIG. 3 illustrates a method 300 for dynamically modifying GPU resource allocations for concurrently running processes, in accordance with an embodiment. The method 300 may be carried out in the context of any of the prior disclosed embodiments. The method 300 may be carried out in the context of any of the embodiments of the prior Figures. For example, the method 300 may be carried out by the GPU resource allocator 202 of FIG. 2. Of course, however, the method 300 may be carried out in any desired context. The aforementioned definitions and descriptions may equally apply to the present embodiments.

In operation 302, a plurality of processes concurrently running on a GPU are monitored. The plurality of processes may be monitored via a map of GPU resources that is periodically updated with a current state of GPU resource allocations to concurrently running processes. The map may be accessed (read) periodically, in an embodiment.

In decision 304, it is determined whether a trigger to dynamically reallocate GPU resources to the processes is detected. The trigger may be one or more predefined events occurring, such as a new process instructed to be executed and/or an existing process completing execution. The trigger may be detected based on the monitoring of the processes in operation 302.

When it is determined that a trigger to dynamically reallocate GPU resources to the processes is not detected, the method 300 returns to operation 302 to continue monitoring the plurality of processes concurrently running on the GPU. When it is determined that a trigger to dynamically reallocate GPU resources to the processes is detected, resource allocations for the plurality of processes are modified in operation 306. The resource allocations may be modified while at least one of the processes is running on the GPU. The method 300 then returns to operation 302 to continue monitoring the plurality of processes concurrently running on the GPU.

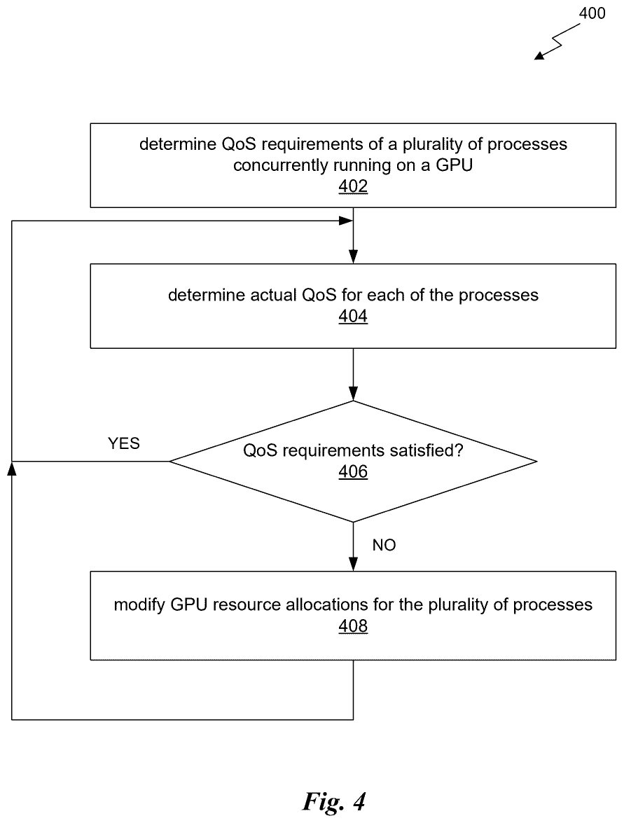

FIG. 4 illustrates a method 400 for dynamically modifying GPU resource allocations to satisfy process QOS requirements, in accordance with an embodiment. The method 400 may be carried out in the context of any of the prior disclosed embodiments. The method 400 may be carried out in the context of any of the embodiments of the prior Figures. For example, the method 400 may be carried out by the GPU resource allocator 202 of FIG. 2. Of course, however, the method 400 may be carried out in any desired context. The aforementioned definitions and descriptions may equally apply to the present embodiments.

In operation 402, QoS requirements of a plurality of processes concurrently running on a GPU are determined. In an embodiment, a QoS requirement of a process may be defined in code from which the corresponding process is created. For example, the code may be annotated by a user to include a QoS requirement via an application programming interface (API).

In operation 404, an actual QoS for each of the processes is determined. The actual QoS for a process may be determined by monitoring execution of the process on the GPU, in an embodiment. In an embodiment, the actual QoS for a process may be determined using performance metrics obtained for the process via hardware performance counters.

In decision 406, it is determined whether the QoS requirements are met. In other words, for each of the processes it is determined whether the actual QoS for the process meets the required QoS defined for the process. When it is determined that the QoS requirements of all of the concurrently running processes are being met, the method 400 returns to operation 404 to again determine the actual QoS for each of the processes (e.g. after a period of time). In other words, operation 404 may be repeated periodically during the method 400.

When it is determined that the QoS requirements of any one of the concurrently running processes is not being met, then GPU resource allocations for the plurality of processes are modified in operation 408. The resource allocations may be modified while at least one of the processes is running on the GPU. The method 400 then returns to operation 404 to again determine the actual QoS for each of the processes (e.g. after a period of time).

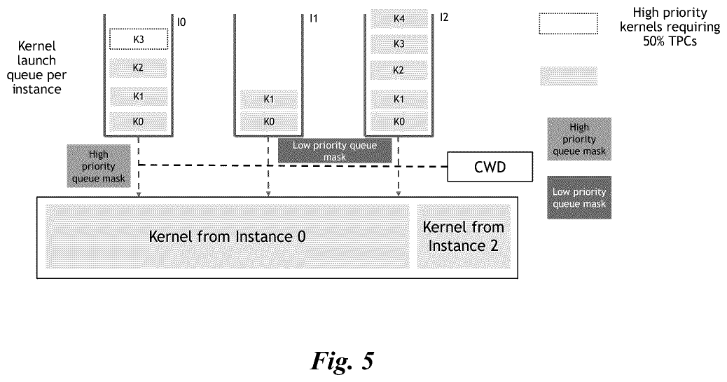

FIG. 5 illustrates a block diagram of a kernel-level GPU resource allocation, in accordance with an embodiment. The kernel-level GPU resource allocation may be implemented in the context of any of the prior disclosed embodiments. The kernel-level GPU resource allocation may be implemented via the system 200 of FIG. 2, for example. The aforementioned definitions and descriptions may equally apply to the present embodiments.

As shown, priority for kernel-level processes is defined on a per-queue basis, as opposed to a per-kernel basis. Multiple kernel-level processes can be added to a single queue for execution by the GPU. In addition, a priority mask is assigned to each queue (I0, I1, I2, in the present embodiment). The priority mask assigned to a queue indicates the priority with which kernel-level processes within the queue are to be executed with respect to the kernel-level processes of other queues. When a new process is to be executed by the GPU, the new process may be added to a queue based on its priority with respect to other concurrently running processes.

GPU resource allocations may be configured such that kernel-level processes in a queue with a higher priority mask are prioritized over kernel-level processes in a queue with a lower priority mask. For example, more GPU resources may be allocated to processes in a queue with a higher priority mask than processes in a queue with a lower priority mask. As a result, execution of the processes in the queue with the higher priority mask may be prioritized, and thus completed, more quickly than processes in the queue with the lower priority mask.

Further, prioritization of processes within a particular queue may not be required, especially as it relates to the higher priority queue. This is because the processes in the higher priority queue will be completed more quickly than processes in the lower priority queues due to the additional GPU resources allocated to them, and thus any later process in the higher priority queue will still reach the front of the queue for execution more quickly as compared with the timing by which processes in the lower priority queues reach the front of their respective queues for execution.

FIG. 6 illustrates a network architecture 600, in accordance with one possible embodiment. As shown, at least one network 602 is provided. In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 604 and an end user computer 606 may be coupled to the network 602 for communication purposes. Such end user computer 606 may include a desktop computer, lap-top computer, and/or any other type of logic. Still yet, various other devices may be coupled to the network 602 including a personal digital assistant (PDA) device 608, a mobile phone device 610, a television 612, a game console 614, a television set-top box 616, etc.

FIG. 7 illustrates an exemplary system 700, in accordance with one embodiment. As an option, the system 700 may be implemented in the context of any of the devices of the network architecture 600 of FIG. 6. Of course, the system 700 may be implemented in any desired environment.

As shown, a system 700 is provided including at least one central processor 701 which is connected to a communication bus 702. The system 700 also includes main memory 704 [e.g. random access memory (RAM), etc.]. The system 700 also includes a graphics processor 706 and a display 708.

The system 700 may also include a secondary storage 710. The secondary storage 710 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 704, the secondary storage 710, and/or any other memory, for that matter. Such computer programs, when executed, enable the system 700 to perform various functions (as set forth above, for example). Memory 704, storage 710 and/or any other storage are possible examples of non-transitory computer-readable media.

The system 700 may also include one or more communication modules 712. The communication module 712 may be operable to facilitate communication between the system 700 and one or more networks, and/or with one or more devices through a variety of possible standard or proprietary communication protocols (e.g. via Bluetooth, Near Field Communication (NFC), Cellular communication, etc.).

As also shown, the system 700 may include one or more input devices 714. The input devices 714 may be wired or wireless input devices. In various embodiments, each input device 714 may include a keyboard, touch pad, touch screen, game controller (e.g. to a game console), remote controller (e.g. to a set-top box or television), or any other device capable of being used by a user to provide input to the system 700.

As described herein, a method, computer readable medium, and system are disclosed to dynamically modify GPU resource allocations among concurrent processes. In accordance with FIGS. 1-5, embodiments may determine GPU resource allocations for concurrently executing processes based on a preconfigured resource allocation policy that may take into consideration execution and performance information. The GPU may then be caused to execute the processes based on the resource allocations. The embodiments may be implemented in hardware and/or software, which in turn may be implemented in the context of any of the devices depicted in FIGS. 6 and/or 7.

What is claimed is:

1. A method, comprising:
at a device:
identifying a current state of allocations of resources of a graphics processing unit (GPU) to a set of processes concurrently executing on the GPU;
detecting at least one change to the set of processes, wherein the at least one change forms a changed set of processes and includes at least one of:
a removal of one or more existing processes from the set of processes,
an addition of one or more new processes to the set of processes, or
a modification to resource requirements of an existing process in the set of processes;
responsive to detecting the at least one change, determining a reallocation of the resources among processes in the changed set of processes, wherein the reallocation targets at least one objective that includes, at least in part, satisfying quality of service requirements defined for one or more processes in the changed set of processes; and
at runtime of at least one process in the changed set of processes, causing the GPU to concurrently execute the changed set of processes in accordance with the reallocation of the resources.

2. The method of claim 1, wherein the processes in the set of processes and the processes in the changed set of processes include at least one of:
application-level processes,
context-level processes,
stream-level processes, or
kernel-level processes.

3. The method of claim 1, wherein the current state indicates at least one of:
usage of GPU resources,
assignments of GPU resources to one or more processes in the set of processes, or
unassigned GPU resources.

4. The method of claim 1, wherein the current state is determined from a map of GPU resources that is periodically updated.

5. The method of claim 1, wherein the current state is updated at one or more assignments of GPU resources and at one or more releases of GPU resources.

6. The method of claim 5, wherein the one or more assignments of GPU resources and the one or more releases of GPU resources are identified from callbacks triggered by hardware.

7. The method of claim 1, wherein the reallocation is further determined based on hardware performance counters that track at least one of:
memory utilization,
cache utilization, or
power utilization.

8. The method of claim 1, wherein the reallocation is further determined based on prioritization among one or more processes in the new set of processes.

9. The method of claim 1, wherein the at least one objective further includes at least one of:
optimizing GPU resource utilization, or
minimizing power consumption.

10. The method of claim 1, wherein the reallocation of the resources is further determined based on historical data indicating one or more previous GPU resource allocations given to at least one process and a resulting performance of the at least one process.

11. The method of claim 1, wherein the method is performed in software.

12. The method of claim 1, wherein the method is performed in hardware.

13. A method, comprising:
at a device:
determining a state of graphics processing unit (GPU) resource allocations to one or more processes; and
at runtime of at least one process of the one or more processes, modifying the GPU resource allocations based on the state and a preconfigured resource allocation policy.

14. The method of claim 13, wherein the one or more processes include application-level processes.

15. The method of claim 13, wherein the one or more processes include context-level processes.

16. The method of claim 13, wherein the one or more processes include stream-level processes.

17. The method of claim 13, wherein the one or more processes include kernel-level processes.

18. The method of claim 13, wherein the state indicates usage of GPU resources.

19. The method of claim 13, wherein the state indicates assignments of GPU resources to the one or more processes.

20. The method of claim 13, wherein the state indicates unassigned GPU resources.

21. The method of claim 13, wherein the state is determined from a map of GPU resources that is periodically updated with a current state of GPU resource allocations.

22. The method of claim 13, wherein the state is updated at one or more assignments of GPU resources and at one or more releases of GPU resources.

23. The method of claim 22, wherein the one or more assignments of GPU resources and the one or more releases of GPU resources are identified from callbacks triggered by hardware.

24. The method of claim 13, further comprising, at the device:
tracking time of utilization of GPU resources.

25. The method of claim 13, further comprising, at the device:
using hardware performance counters to track at least one of:
memory utilization,
cache utilization, or
power utilization.

26. The method of claim 25, wherein the GPU resource allocations are further modified based on the hardware performance counters.

27. The method of claim 13, wherein the preconfigured resource allocation policy is a function that determines a target GPU resource allocation for the one or more processes based on the state.

28. The method of claim 27, wherein the preconfigured resource allocation policy determines the target GPU resource allocation for the one or more processes according to one or more defined parameters.

29. The method of claim 28, wherein the one or more defined parameters include a prioritization among the one or more processes.

30. The method of claim 28, wherein the one or more defined parameters include quality of service requirements of the one or more processes.

31. The method of claim 28, wherein the one or more defined parameters include an objective for GPU resource allocation.

32. The method of claim 31, wherein the objective includes at least one of:
optimize GPU resource utilization,
minimize power consumption, or
adhere to quality of service requirements of the one or more processes.

33. The method of claim 28, wherein at least one parameter of the one or more defined parameters is defined by a user.

34. The method of claim 27, wherein the preconfigured resource allocation policy determines the target GPU resource allocation for the one or more processes based on historical data indicating one or more previous GPU resource allocations given to at least one process of the one or more processes and a resulting performance of the at least one process.

35. The method of claim 27, wherein the GPU resource allocations are modified in accordance with the target GPU resource allocation.

36. The method of claim 13, wherein modifying the GPU resource allocations includes adjusting an allocation of GPU resources among the one or more processes.

37. The method of claim 36, wherein modifying the GPU resource allocations includes instructing the GPU to adjust the allocation of GPU resources among the one or more processes.

38. The method of claim 13, wherein the GPU resource allocations are modified by:
allocating a predefined amount of GPU resources to a first queue storing a first plurality of kernels, wherein the first queue stores at least one kernel to be prioritized over other kernels, and
allocating remaining GPU resources among remaining queues each storing a respective plurality of kernels.

39. The method of claim 13, wherein the determining and the modifying are performed in software.

40. The method of claim 39, wherein the software determines the state from information provided by the GPU to a shared memory.

41. The method of claim 13, wherein the determining and the modifying are performed in hardware.

42. The method of claim 41, wherein the hardware is the GPU.

43. A system, comprising:
at least one of hardware of a computer or software stored on a non-transitory memory storage of the computer and executable by a processor of the computer, wherein the at least one of the hardware or the software is configured to:
determine a state of graphics processing unit (GPU) resource allocations to one or more processes; and
at runtime of at least one process of the one or more processes, modify the GPU resource allocations based on the state and a preconfigured resource allocation policy.

44. The system of claim 43, wherein the hardware performs the determining and the modifying.

45. The system of claim 44, wherein the hardware is the GPU.

46. The system of claim 43, wherein the software performs the determining and the modifying.

47. The system of claim 43, further comprising a shared memory, wherein the GPU provides information to the shared memory for use by the software in determining the state.

48. A non-transitory computer-readable media storing software which when executed by one or more processors of a device cause the device to:
determine a state of graphics processing unit (GPU) resource allocations to one or more processes; and
at runtime of at least one process of the one or more processes, modify the GPU resource allocations based on the state and a preconfigured resource allocation policy.

49. The non-transitory computer-readable media of claim 48, wherein the one or more processes include at least one of:
application-level processes,
context-level processes,
stream-level processes, or
kernel-level processes.

50. The non-transitory computer-readable media of claim 48, wherein the state indicates at least one of:
usage of GPU resources,
assignments of GPU resources to the one or more processes, or
unassigned GPU resources.

51. The non-transitory computer-readable media of claim 48, wherein the preconfigured resource allocation policy is a function that determines a target GPU resource allocation for the one or more processes based on the state, wherein the target GPU resource allocation is determined based on at least one of:
prioritization among the one or more processes,
quality of service requirements of the one or more processes, or
an objective for GPU resource allocation.

52. The non-transitory computer-readable media of claim 51, wherein the objective includes at least one of:
optimize GPU resource utilization,
minimize power consumption, or
adhere to quality of service requirements of the one or more processes.
